(19) United States
(12) Patent Application Publication
(10) Pub. No.: US 2026/0225529 A1
(43) Pub. Date: Aug. 6, 2026

(54) VEHICLE DISPLAY CONTROL METHOD AND VEHICLE DISPLAY CONTROL DEVICE

(71) Applicant: Panasonic Automotive Systems Co., Ltd., Kanagawa (JP)

(72) Inventor: Yuta SUDO, Tokyo To (JP)

(73) Assignee: Panasonic Automotive Systems Co., Ltd., Kanagawa (JP)

(21) Appl. No.: 19/423,713

(22) Filed: Dec. 17, 2025

(30) Foreign Application Priority Data
Jan. 31, 2025 (JP) 2025-014486

(51) Int. Cl. B60R 1/27; B60R 1/12

(52) U.S. Cl. CPC B60R 1/27; B60R 1/12; B60R 2001/1253; B60R 2300/105; B60R 2300/302; B60R 2300/602; B60R 2300/607

(57) ABSTRACT

A vehicle display control method is implemented by a computer in a vehicle. The vehicle includes a camera to acquire a first peripheral video in a first direction from a first viewpoint. The method includes generating, based on the first peripheral video, a second peripheral video in a second direction from a second viewpoint at a position higher than the first viewpoint by using a learning model. The learning model is trained based on first/second training videos. The first training video is acquired by a first learning camera in the first direction at the first viewpoint. The second training video is acquired by a second learning camera in the second direction at the second viewpoint. The method includes causing a display device provided in the vehicle to display an overhead view video viewed from an overhead viewpoint higher than the first viewpoint by using the second peripheral video.

### CROSS-REFERENCE TO RELATED APPLICATIONS

This application is based upon and claims the benefit of priority from Japanese Patent Application No. 2025-014486, filed on January 31, 2025, the entire contents of which are incorporated herein by reference.

### FIELD

The present disclosure relates generally to a vehicle display control method and a vehicle display control device.

### BACKGROUND

There is technology of generating and displaying an overhead view video representing a vehicle viewed from above by combining videos obtained by capturing the periphery of the vehicle (See, for example, Patent Literature: WO 2013/088613 A).

However, in the related art, a composite video, in which a three-dimensional object present around a vehicle is illustrated two-dimensionally, is used as an overhead view video. Therefore, an unnatural display video is displayed, which is different from the state where the vehicle is virtually captured from above.

There is a demand for displaying video that is similar to the state in which a vehicle is photographed from above.

### SUMMARY

A vehicle display control method according to one aspect of the present disclosure is implemented by a computer as a vehicle display control device provided in a vehicle. The vehicle includes a camera and a display device. The camera serves to acquire a first peripheral video in a first direction from a first viewpoint. The display device enables a passenger to visually recognize video. The vehicle display control method includes generating, based on the first peripheral video, a second peripheral video in a second direction from a second viewpoint at a position higher than the first viewpoint by using a learning model. The learning model is trained based on a first training video and a second training video. The first training video is acquired by a first learning camera in the first direction at the first viewpoint. The second training video is acquired by a second learning camera in the second direction at the second viewpoint; . The vehicle display control method includes causing the display device to display an overhead view video viewed from an overhead viewpoint higher than the first viewpoint by using the second peripheral video.

### BRIEF DESCRIPTION OF THE DRAWINGS

FIG. 1 is a block diagram illustrating an example of an overall configuration of a vehicle;

FIG. 2 is an explanatory diagram of an example of arrangement of a sensor and a camera;

FIG. 3 is a schematic diagram illustrating an exemplary configuration of the external appearance of a vehicle;

FIG. 4 is a diagram illustrating an exemplary configuration of the vehicle in the vicinity of the driver's seat;

FIG. 5 is an explanatory diagram of an example of a projection plane;

FIG. 6 is a schematic diagram of an example of a display video;

FIG. 7 is a schematic diagram of an example of a conventional display video;

FIG. 8 is a flowchart illustrating an example of a procedure of information processing executed by a control unit;

FIG. 9A is a detailed explanatory diagram of an exemplary disposition of a camera;

FIG. 9B is a detailed explanatory diagram of an exemplary disposition of a camera;

FIG. 10 is an explanatory diagram of an example of vehicle display control;

FIG. 11 is an explanatory diagram of an example of a positional relationship of viewpoints;

FIG. 12 is an explanatory diagram of an example of processing using a learning model by the control unit;

FIG. 13A is a schematic diagram of an example of a first training video;

FIG. 13B is a schematic diagram of an example of a second training video;

FIG. 14 is a schematic diagram of an example of an overhead view video;

FIG. 15 is a flowchart illustrating an example of a procedure of information processing executed by the control unit; and

FIG. 16 is a block diagram illustrating a hardware configuration example of a vehicle control device.

### DETAILED DESCRIPTION

Hereinafter, embodiments of a vehicle display control method and a vehicle display control device according to the present disclosure will be described with reference to the drawings.

In the following description of the embodiments, the same reference numerals are given to the same parts, and redundant description will be omitted.

### First Embodiment

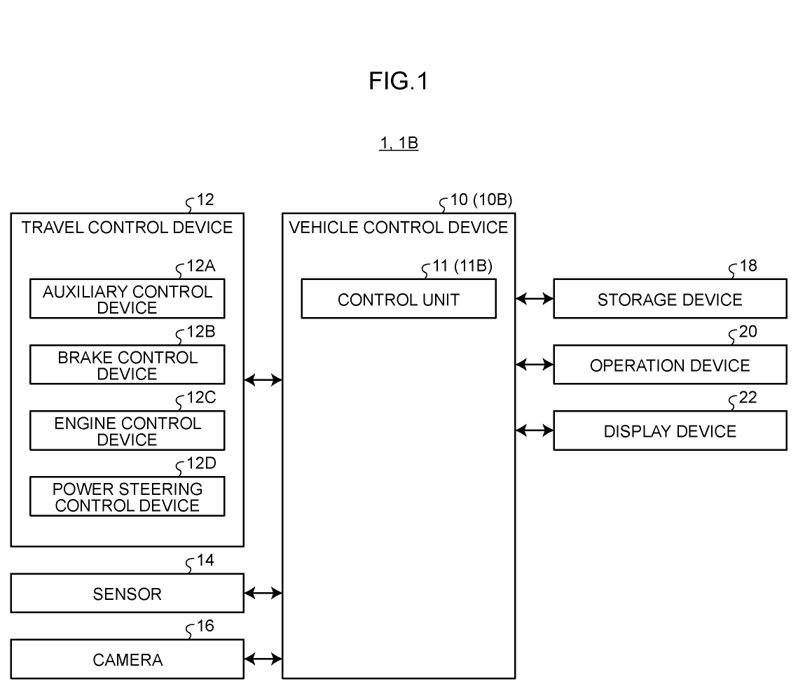

FIG. 1 is a block diagram illustrating an example of an overall configuration of a vehicle 1.

The vehicle 1 includes a vehicle control device 10, a travel control device 12, a sensor 14, a camera 16, a storage device 18, an operation device 20, and a display device 22.

The vehicle control device 10 is an example of a vehicle display control device. A vehicle control method executed by the vehicle control device 10 is an example of a vehicle display control method.

The travel control device 12, the sensor 14, the camera 16, the storage device 18, the operation device 20, and the display device 22 are connected to the vehicle control device 10 in such a manner as to be able to exchange data or signals. Thus, the vehicle control device 10 is set to be communicably connected to at least the operation device 20, the camera 16, the display device 22, and the travel control device 12.

The travel control device 12 controls at least acceleration and deceleration and steering of the vehicle 1. The travel control device 12 is a means for implementing driving, braking, and turning motions necessary for traveling of the vehicle 1. For example, the travel control device 12 includes a driving motor, a power transmission mechanism, a brake device, a steering device, and the like, and an electronic vehicle control device that controls these components. The travel control device 12 causes the vehicle 1 to travel by, for example, generating power by the driving motor and transmitting the power to wheels via the power transmission mechanism. The power transmission mechanism is, for example, a propeller shaft, a differential gear, a drive shaft, or the like.

Controlling at least steering means that the travel control device 12 controls at least one of driving, braking, or turning motions necessary for traveling of the vehicle 1. The controlling of steering means that the travel control device 12 controls at least one of the turning direction by steering, the vehicle speed and acceleration by accelerator steering, or deceleration and stopping by brake steering. Controlling at least acceleration and deceleration means that the travel control device 12 controls at least one of acceleration or deceleration of the vehicle 1.

Specifically, the travel control device 12 includes an auxiliary control device 12A, a brake control device 12B, an engine control device 12C, and a power steering control device 12D. The brake control device 12B, the engine control device 12C, and the power steering control device 12D can be collectively referred to as an actuator control unit that controls the operation of the vehicle 1.

The auxiliary control device 12A is a control device that monitors the transmission state of the vehicle control device 10 and operates to execute appropriate degeneration control as a backup when the vehicle control device 10 fails. Note that even in a case where the vehicle control device 10 fails, if safety can be secured by providing a degeneration control function in the vehicle control device 10, the degeneration control is unnecessary.

The brake control device 12B is a control device that performs brake control of the vehicle 1. The brake control may be referred to as braking force control. For example, the brake control device 12B performs brake control of the vehicle 1 depending on enhancement and relaxation of the operation of a brake pedal by a passenger. The enhancement of the operation of the brake pedal by the passenger specifically means depression of the brake pedal by the passenger. The brake control device 12B performs brake control depending on a peripheral video during autonomous traveling.

The engine control device 12C is a control device that controls an engine that generates a driving force of the vehicle 1. The power steering control device 12D is a control device that controls power steering of the vehicle 1.

The sensor 14 is provided in the vehicle 1 to acquire at least the situation outside the vehicle 1. Specifically, the sensor 14 includes various sensors that detect the traveling state of the vehicle 1 and the situation outside the vehicle 1. The sensor 14 includes, for example, an accelerator opening sensor that detects the degree of opening of the accelerator, a steering angle sensor that detects a steering angle of the steering device, an acceleration sensor that detects acceleration acting in the front-rear direction of the vehicle 1, a torque sensor that detects torque acting on the power transmission mechanism between the wheels and the driving motor of the vehicle 1, a vehicle speed sensor that detects the vehicle speed of the vehicle 1, a wheel speed sensor, a global positioning system (GPS), and the like. In addition, the sensor 14 includes at least one of a light detection and ranging (LiDAR), a radar, a sonar, and an ultrasonic sensor. Moreover, the sensor 14 may include a device in which structure from motion (SfM) technology by measuring the distance from a peripheral video captured by a monocular camera is used.

The sensor 14 outputs sensor information obtained by the detection to the vehicle control device 10.

The camera 16 is a peripheral sensor that is provided in the vehicle 1 to monitor the peripheral environment of the vehicle 1. The camera 16 includes an imaging element. In the present embodiment, the camera 16 photographs the periphery of the vehicle 1 and outputs peripheral video data obtained by the photographing to the vehicle control device 10. The peripheral video data includes multiple pieces of photographed image data obtained by capturing the periphery of the vehicle 1 in time series. Hereinafter, the peripheral video data will be simply referred to as a peripheral video. In the present embodiment, the camera 16 is also applied to an application of detecting an object such as a three-dimensional object present around the vehicle 1 and estimating the position of the vehicle 1 from the positional relationship between the vehicle 1 and the object present around the vehicle 1.

The camera 16 and at least one of a light detection and ranging (LiDAR), a radar, a sonar, an ultrasonic sensor, or a device using an SfM technology included in the sensor 14 are examples of a three-dimensional object sensor that detects a three-dimensional object.

The position, the number of installations, and the imaging direction of the camera 16 are adjusted in advance such that the periphery of the vehicle 1 can be photographed. For example, the vehicle 1 is provided with four cameras 16 arranged in such a manner as to be able to capture images in four directions of a front direction, a rear direction, a left direction, and a right direction of the vehicle 1. Note that the number of cameras 16 provided in the vehicle 1 is not limited to four.

The storage device 18 stores various data.

The storage device 18 is an auxiliary storage device such as a hard disk drive (HDD), a solid state drive (SSD), or a flash memory. Note that at least some pieces of data in the storage device 18 may be stored in an external storage device such as a server device provided outside the vehicle 1 and communicably connected to the vehicle control device 10.

The operation device 20 receives an operation by a passenger of the vehicle 1. The operation device 20 includes operation mechanisms related to driving operations such as a steering wheel, a shift lever for shifting a transmission, an accelerator pedal, a brake pedal, a blinker lever, and a push-in switch and an input device such as a keyboard, a touch panel, and a switch. The steering angle of the steering device is adjusted by the operation of a steering operation unit by the passenger. At least one of the keyboard, the touch panel, and the switch functions as an autonomous parking instruction unit that receives an autonomous parking start instruction. The steering wheel is an example of the steering operation unit. The steering wheel may be referred to as a handle.

The shift lever is an example of a forward and reverse operation unit. The forward and reverse operation unit switches at least forward traveling and backward traveling of the vehicle 1. The brake pedal is an example of a brake operation unit. The brake operation unit is an operation unit for a brake that suppresses the speed of the vehicle 1. The brake operation unit receives an instruction to decelerate the vehicle 1. The operation device 20 may constitute part of a human machine interface (HMI) or part of an in-vehicle infotainment (IVI).

The display device 22 is a display that outputs various images. The display device 22 is installed at a position visually recognizable by a passenger of the vehicle 1. Examples of the display include a liquid crystal display (LCD), an organic electro-luminescence (EL) display, and a projector. A touch panel display may be employed in which the display device 22 and the operation device 20 are integrally configured. The display device 22 is an example of at least one of the HMI and the IVI.

The display device 22 is not limited to those including only one display area. For example, the display device 22 may include a plurality of display areas.

The vehicle 1 may include a plurality of display devices 22. For example, the display device 22 may include a first display unit and a second display unit, the first display unit and the second display unit being displays that output various images. The first display unit and the second display unit are display devices 22 configured as separate bodies. The first display unit and the second display unit may be arranged at different positions in the vehicle 1. For example, the first display unit may function as the IVI, and the second display unit may function as part of an instrument panel of the vehicle 1.

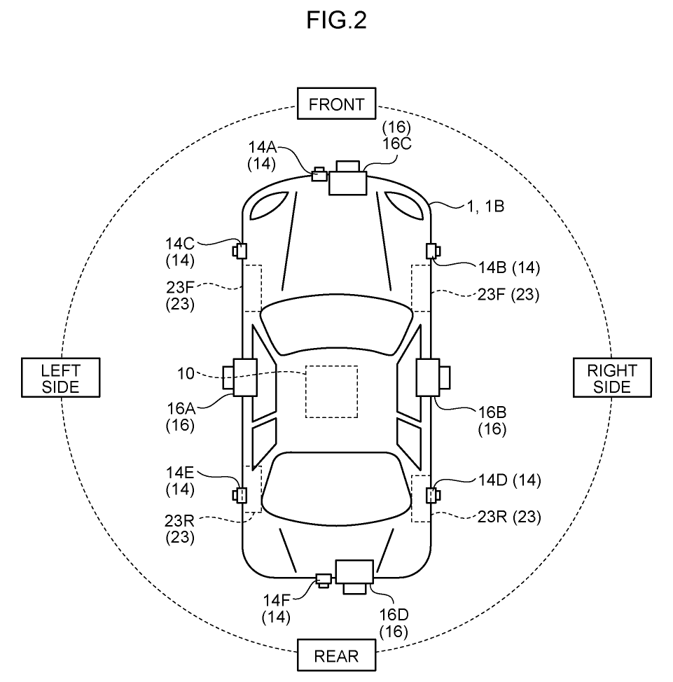

FIG. 2 is an explanatory diagram of an example of arrangement of the sensors 14 and the cameras 16.

The vehicle 1 is provided with, for example, four cameras 16 (first camera 16A to fourth camera 16D) in such a manner as to be able to acquire the situation outside the vehicle 1, for example, in at least four directions of the front, rear, right side, and left side of the vehicle 1.

Specifically, for example, the cameras 16 include a first camera 16A, a second camera 16B, a third camera 16C, and a fourth camera 16D. The first camera 16A is disposed on a left side of the vehicle 1 and captures an image of the left side of the vehicle 1. The second camera 16B is disposed on the right side of the vehicle 1 and captures an image of the right side of the vehicle 1. The third camera 16C is disposed on the front side of the vehicle 1 and captures an image of the front side of the vehicle 1. The third camera 16C may be referred to as a front camera. The fourth camera 16D is disposed on the rear side of the vehicle 1 and captures an image of the rear side of the vehicle 1. The fourth camera 16D may be referred to as a rear camera or the like.

Note that the number of cameras 16 provided in the vehicle 1 is not limited to four. In addition, regarding sensors that detect objects such as a lidar, a radar, a sonar, or an ultrasonic sensor included in the sensors 14, it is preferable that the arrangement positions, the number of arranged items, and the like are adjusted in advance such that the external situation of the right side, the left side, the front side, and the rear side of the vehicle 1 can be acquired. For example, as illustrated in FIG. 2, the sensors 14 include sensors 14A to 14F. These sensors 14A to 14F are arranged in the vehicle 1 in such a manner as to be able to acquire external situation of the right side, the left side, the front side, and the rear side of the vehicle 1.

Next, the configuration of the vehicle 1 will be described.

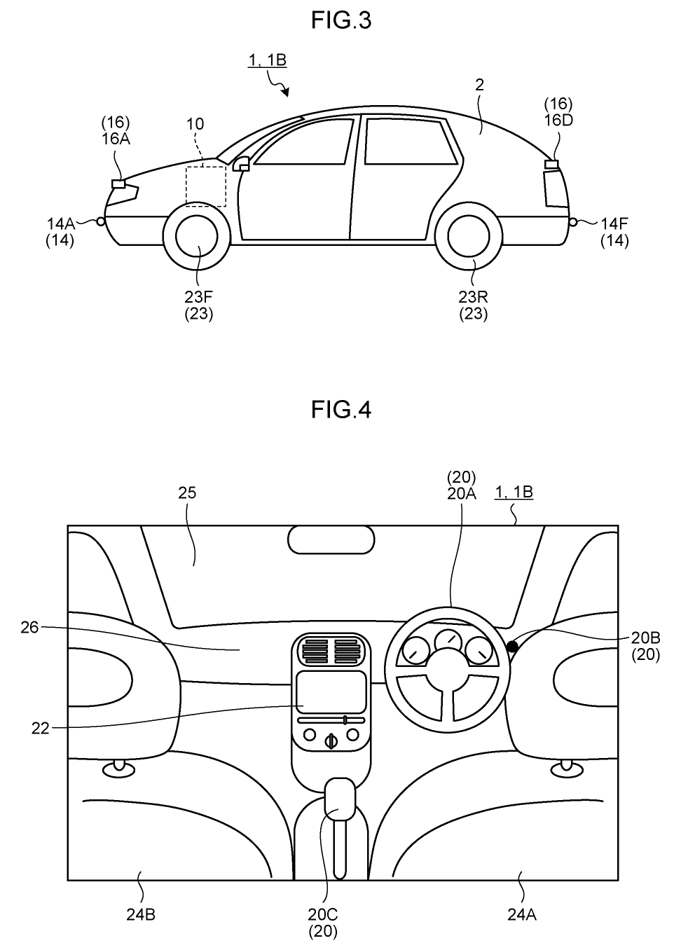

FIG. 3 is a schematic diagram illustrating an exemplary configuration of the external appearance of the vehicle 1.

The vehicle 1 includes a vehicle body 2 and two pairs of wheels 23 arranged in a predetermined direction in the vehicle body 2. The two pairs of wheels 23 include a pair of front tires 23F and a pair of rear tires 23R (see also FIG. 2). Note that FIGS. 2 and 3 illustrate an example in which the vehicle 1 includes four wheels 23. However, the number of wheels 23 provided in the vehicle 1 is not limited thereto.

Next, the configuration of the vehicle 1 of the present embodiment in the vicinity of the driver's seat will be described.

FIG. 4 is a diagram illustrating an exemplary configuration of the vehicle 1 of the present embodiment in the vicinity of a driver's seat 24A.

The vehicle 1 includes the driver's seat 24A and a passenger seat 24B. A windshield 25, a dashboard 26, a steering wheel 20A, an operation button 20B, and a display device 22 are provided in front of the driver's seat 24A. A shift lever 20C, which is a lever for shifting the transmission, is provided in the vicinity of the driver's seat 24A.

The steering wheel 20A, the operation button 20B, and the shift lever 20C are examples of the operation device 20.

The steering wheel 20A is provided in front of the driver's seat 24A and can be operated by a passenger. The turning angle of the steering wheel 20A, namely, the steering angle is electrically or mechanically interlocked with the change in the direction of the front tires 23F, which are steered wheels. Note that the steered wheels may be the rear tires 23R or both the front tires 23F and the rear tires 23R.

The operation button 20B is a button capable of receiving an operation by a passenger. The operation button 20B may include a direction indicator. The position of the operation button 20B is not limited to the example illustrated in FIG. 4 and may be provided, for example, on the steering wheel 20A. Although one operation button 20B is illustrated in FIG. 4, a plurality of operation buttons 20B may be provided. In a case where the display device 22 also serves as a touch panel, the display device 22 may be an example of the operation device 20.

Returning to FIG. 1, the description will be continued.

The vehicle control device 10 is an electronic control unit that integrally controls the units of the vehicle 1. As described above, the vehicle control device 10 is an example of the vehicle display control device. Moreover, a vehicle control method executed by the vehicle control device 10 is an example of the vehicle display control method.

The vehicle control device 10 controls the travel control device 12 such that the traveling state of the vehicle 1 is optimized by using sensor information, peripheral videos, and the like received from the sensors 14 and the cameras 16, respectively. In addition, the vehicle control device 10 controls the travel control device 12 to cause the vehicle 1 to autonomously travel.

The vehicle control device 10 includes a control unit 11. A part or all of the control unit 11 may be configured as software implemented by cooperation of a processor and various programs stored in a memory. In addition, a part or all of the control unit 11 may be configured as hardware implemented by a dedicated circuit or the like.

The control unit 11 integrally controls the units of the vehicle 1.

In the present embodiment, the control unit 11 causes the display device 22 to display a display video obtained by converting a peripheral video obtained by at least one camera 16 in such a manner as to project the peripheral video on a projection plane. In other words, the control unit 11 causes the display device 22 to display a display video, which is a projection video obtained by projecting the peripheral video obtained by the camera 16 on a projection plane adjusted by processing to be described later, as an overhead view video of the vehicle 1 captured from above.

The projection plane is an image projection plane virtually disposed in a virtual space corresponding to the real space.

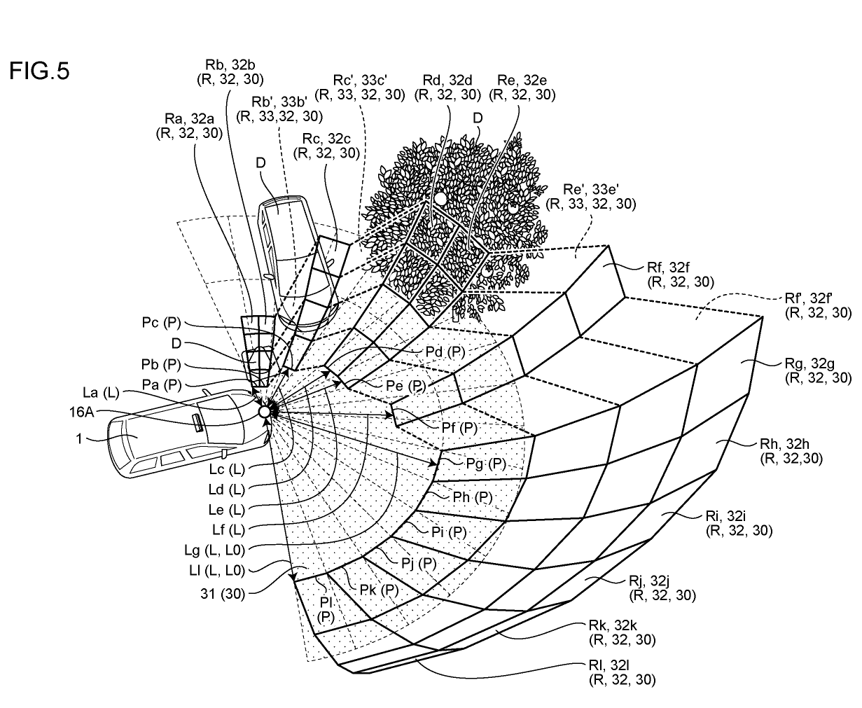

FIG. 5 is an explanatory diagram of an example of a projection plane 30. FIG. 5 illustrates, as an example, a projection plane 30 after being adjusted by adjustment processing and the like by the control unit 11, the adjustment processing to be described later.

The control unit 11 first sets a virtual projection plane 30 rising from a position away from the vehicle 1 by a predetermined distance L. In a stage before the control unit 11 sets the virtual projection plane 30 and executes adjustment processing of a partial projection plane 32 to be described later, the projection plane 30 has a bowl shape. The bowl shape includes a bottom plane of a two-dimensional plane and a side wall plane continuous with the bottom plane and erected from the bottom plane in a direction intersecting the bottom plane. A cross-section of the side wall plane cut in a direction perpendicular to the bottom plane has a substantially arc shape.

The projection plane 30 includes a road surface projection plane 31 and a plurality of partial projection planes 32. Although details will be described later, the projection plane 30 may further include a connecting partial projection plane 33 by adjustment processing by the control unit 11, the adjustment processing to be described later.

The road surface projection plane 31 is a virtual road surface corresponding to a road surface on which the vehicle 1 travels in the real space. The road surface projection plane 31 corresponds to the bottom plane of the projection plane 30. The road surface projection plane 31 is a two-dimensional plane in the horizontal direction corresponding to the road surface on which the vehicle 1 travels. In addition, in a stage before the control unit 11 sets the virtual projection plane 30 and executes adjustment processing of the partial projection plane 32 to be described later, the road surface projection plane 31 has a fan shape encircled by two radii of the same distance L of the circle centered on the vehicle 1 and an arc therebetween.

A partial projection plane 32 is a virtual projection plane for each area obtained by dividing a space around the vehicle 1 into multiple areas for each predetermined azimuth range R around the vehicle 1. A partial projection plane 32 constitutes part of the side wall plane erected in a direction intersecting the road surface projection plane 31 which is the bottom plane of the bowl-shaped projection plane 30. FIG. 5 illustrates, as an example of partial projection planes 32, partial projection planes 32 (partial projection planes 32a to 32l) corresponding to respective azimuth ranges R of mutually different azimuths (azimuth ranges Ra to Rl).

The partial projection planes 32 (partial projection planes 32a to 32l) corresponding to the respective azimuth ranges R (azimuth ranges Ra to Rl) having mutually different azimuths are arranged in such a manner as to rise from rising positions P (rising positions Pa to Pl), which are positions on the road surface projection plane 31. Rising from a rising position P means erecting from the virtual two-dimensional road surface projection plane 31 in a direction intersecting the road surface projection plane 31 and in a direction opposite to the vertical direction.

In the present embodiment, the control unit 11 sets, for each of the cameras 16 provided in the vehicle 1, the substantially fan-shaped virtual road surface projection plane 31 centered on the camera 16 and the virtual partial projection planes 32 each extending radially in a direction away from the vehicle 1 and rising from a rising position P, which is a position away from the camera 16 by a predetermined distance L (initial distance L0), for one of the azimuth ranges R having different azimuths. The control unit 11 sets the substantially bowl-shaped projection plane 30 on which the vehicle 1 is disposed at the center of the road surface projection plane 31 by executing the setting processing for each of the cameras 16 provided in the vehicle 1.

Therefore, for example, in the initial state, namely, in a stage before the adjustment processing of the partial projection planes 32 to be described later is executed, the projection plane 30 is set which includes the road surface projection plane 31 and the partial projection planes 32 rising from the rising position P at the initial distance L0 that is a predetermined distance from the vehicle 1 on the road surface projection plane 31 for respective azimuth ranges R having different azimuths.

In the example illustrated in FIG. 5, a partial projection plane 32g to a partial projection plane 32l rising from rising positions P (rising position Pg to rising position Pl, respectively) separated from the vehicle 1 by the initial distance L0 in an azimuth range Rg to an azimuth range Rl, respectively, from the vehicle 1 correspond to the partial projection planes 32 at the stage before executing the adjustment processing of the partial projection planes 32 described later.

Note that, in order to simplify the description, FIG. 5 illustrates the road surface projection plane 31 which is a substantially fan-shaped area centered on the third camera 16C of the vehicle 1 and the virtual partial projection planes 32 rising from the road surface projection plane 31. In FIG. 5, a part of the substantially bowl-shaped projection plane 30 centered on the vehicle 1 is illustrated. In practice, the projection plane 30 includes a group of a road surface projection plane 31 centered on each of the cameras 16 provided in the vehicle 1 and virtual partial projection planes 32 rising from the road surface projection plane 31.

The control unit 11 determines whether or not a three-dimensional object D has been detected for each azimuth range R. When detecting the three-dimensional object D, the control unit 11 derives a distance from the vehicle 1 to the three-dimensional object D.

The three-dimensional object D is a three-dimensional object present in the real space. The three-dimensional object D is, for example, a structure such as a pillar, a living object such as a person, a traveling object such as another vehicle, or the like.

The control unit 11 obtains the detection result of the three-dimensional object D detected by the three-dimensional object sensor, thereby deriving whether or not the three-dimensional object D is detected and the distance to the three-dimensional object D for each of the azimuth ranges R.

As described above, at least one of the LiDAR, the radar, the sonar, or the ultrasonic sensor included in the at least one camera 16 and a sensor 14 is an example of the three-dimensional object sensor that detects the three-dimensional object D.

The control unit 11 analyzes sensor information detected by at least one of the LiDAR, the radar, the sonar, or the ultrasonic sensor by a known method, thereby deriving whether or not the three-dimensional object D is detected and the distance to the three-dimensional object D for each azimuth range R. The control unit 11 may derive whether or not the three-dimensional object D is detected and the distance to the three-dimensional object D for each azimuth range R by analyzing a peripheral video captured by the camera 16 by a known method.

For example, the control unit 11 may derive whether or not the three-dimensional object D is detected and the distance to the three-dimensional object D for each azimuth range R by using a learning model such as a pre-trained convolution neural network (CNN) in which the sensor information or the peripheral video captured by the camera 16 is used as input and whether or not the three-dimensional object D is detected and the distance from the vehicle 1 to the three-dimensional object D for each azimuth range R are used as output.

Moreover, on the three-dimensional object sensor side, whether or not the three-dimensional object D is detected and the distance to the three-dimensional object D for each azimuth range R may be detected by using the learning model or the like based on the peripheral video or the sensor information. In this case, the control unit 11 may derive whether or not the three-dimensional object D is detected and the distance to the three-dimensional object D for each azimuth range R by acquiring a detection result indicating whether or not the three-dimensional object D is detected and the distance to the three-dimensional object D from the three-dimensional object sensor for each azimuth range R.

Furthermore, the control unit 11 may acquire a free space for each azimuth range R by using a learning model such as a pre-trained convolutional neural network that receives the sensor information or the peripheral video captured by the camera 16 as input and outputs a free space that is a region where no three-dimensional object D is included for each azimuth range R in the peripheral video. Then, the control unit 11 may derive whether or not the three-dimensional object D is detected and the distance to the three-dimensional object D for each azimuth range R by a known method using the free space and the peripheral video captured by the camera 16.

Then, the control unit 11 adjusts the rising position P of each of the partial projection planes 32 corresponding to one of the azimuth ranges R depending on whether or not the three-dimensional object D is detected in the corresponding azimuth range R.

Specifically, assume a case in which the three-dimensional object D is detected in a certain azimuth range R among the azimuth ranges R around the vehicle 1, and the three-dimensional object D is not detected in another azimuth range R different from this azimuth range R. In this case, the control unit 11 sets the distance L from the vehicle 1 to the rising position P of a partial projection plane 32 corresponding to the azimuth range R in which the three-dimensional object D has been detected to be shorter than the distance L from the vehicle 1 to the rising position P of a partial projection plane 32 corresponding to the other azimuth range R in which the three-dimensional object D is not detected.

Specifically, assume a case where the three-dimensional object sensor detects the three-dimensional object D in the certain azimuth range R (first azimuth range R) and does not detect the three-dimensional object D in another azimuth range R (second azimuth range R) different from this azimuth range R. In this case, the control unit 11 sets the distance L (first distance) from the vehicle 1 to the rising position P (first rising position) of the partial projection plane 32 (first partial projection plane) corresponding to the first azimuth range R shorter than the distance L (second distance) from the vehicle 1 to the rising position P (second rising position) of the partial projection plane 32 (second partial projection plane) corresponding to the second azimuth range R.

It is also based on a premise that the three-dimensional object sensor detects the three-dimensional object D in a certain azimuth range R (first azimuth range R), does not detect the three-dimensional object D in another azimuth range R (second azimuth range R) different from this azimuth range R, and does not detect the three-dimensional object D in other azimuth ranges R (third azimuth range R) different from these azimuth ranges R.

In this case, the control unit 11 sets the distance L (first distance) from the vehicle 1 to the rising position P (first rising position) of the partial projection plane 32 (first partial projection plane) corresponding to the first azimuth range R shorter than the distance L (second distance) from the vehicle 1 to the rising position P (second rising position) of the partial projection plane 32 (second partial projection plane) corresponding to the second azimuth range R. In addition, the control unit 11 sets the distance L (first distance) from the vehicle 1 to the rising position P (first rising position) of the partial projection plane 32 (first partial projection plane) corresponding to the first azimuth range R shorter than the distance L (third distance) from the vehicle 1 to the rising position P (third rising position) of the partial projection plane 32 (third partial projection plane) corresponding to the third azimuth range R.

As described above, the rising positions P such as the first rising position, the second rising position, and the third rising position are positions on the road surface projection plane 31. Incidentally, the first distance and the second distance may be the same distance L.

FIG. 5 illustrates, as an example, a mode in which the three-dimensional object sensor detects the three-dimensional object D in each of the azimuth ranges R of the azimuth range Ra, the azimuth range Rb, the azimuth range Rc, the azimuth range Rd, and the azimuth range Re.

Specifically, for example, assume a case in which the three-dimensional object sensor has detected the three-dimensional object D in the azimuth range Re and has not detected the three-dimensional object D in the azimuth range Rg to the azimuth range Rl. In this case, the control unit 11 sets a distance Le from the vehicle 1 to a rising position Pe of a partial projection plane 32e corresponding to the azimuth range Re shorter than the distance L from the vehicle 1 to the rising positions P (rising position Pg to rising position Pl) of the partial projection planes 32 corresponding to the respective azimuth ranges Rg to Rl (see FIG. 5). Therefore, as illustrated in FIG. 5, the distance Le from the vehicle 1 to the rising position Pe of the partial projection plane 32e corresponding to the azimuth range Re in which the three-dimensional object D has been detected is adjusted to be shorter than the initial distance L0 and shorter than the distance L from the vehicle 1 to the rising position P of a partial projection plane 32 in an azimuth range R in which the three-dimensional object D is not detected.

Similarly, the control unit 11 adjusts the distance L of the rising position P from the vehicle 1 in other azimuth ranges R(azimuth range Ra, azimuth range Rb, azimuth range Rc, and azimuth range Rd) in which the three-dimensional object D has been detected, similarly to the azimuth range Re.

Furthermore, in a case where the three-dimensional object D is detected in a certain azimuth range R and the three-dimensional object D is not detected in another azimuth range R different from this azimuth range R, the control unit 11 may further adjust the rising position P of the road surface projection plane 31 corresponding to the azimuth range R in which the three-dimensional object D has been detected to a position corresponding to the position of the detected three-dimensional object D.

Specifically, in a case where the three-dimensional object sensor detects the three-dimensional object D in a certain azimuth range R (first azimuth range R) and does not detect the three-dimensional object D in another azimuth range R (second azimuth range R) different from this azimuth range R, the rising position P (first rising position) of the partial projection plane 32 (first partial projection plane) corresponding to the first azimuth range R corresponds to the position of the detected three-dimensional object D.

Specifically, the control unit 11 sets the distance L from the vehicle 1 to the rising position P of a partial projection plane 32 corresponding to the azimuth range R in which the three-dimensional object D has been detected to be shorter than the distance L from the vehicle 1 to the rising position P of a partial projection plane 32 corresponding to the other azimuth range R in which the three-dimensional object D is not detected. Then, for the azimuth range R in which the conditions for the distance L are satisfied and the three-dimensional object D has been detected, the control unit 11 adjusts the rising position P of the partial projection plane 32 such that the distance L between the vehicle 1 and the rising position P of the partial projection plane 32 corresponding to the azimuth range R becomes smaller (shorter) as the distance from the vehicle 1 to the three-dimensional object D is shorter. Furthermore, for the azimuth range R in which the conditions for the distance L are satisfied and the three-dimensional object D has been detected, the control unit 11 adjusts the rising position P of the partial projection plane 32 such that the distance L between the vehicle 1 and the rising position P of the partial projection plane 32 corresponding to the azimuth range R becomes larger (longer) as the distance from the vehicle 1 to the three-dimensional object D is longer.

Therefore, as illustrated in FIG. 5, the rising position P of the partial projection plane 32 corresponding to the azimuth range R in which the three-dimensional object D has been detected is adjusted to a rising position P corresponding to the distance from the detected three-dimensional object D to the vehicle 1.

At this point, with the control unit 11 adjusting the rising position P of the partial projection plane 32 corresponding to the azimuth range R in which the three-dimensional object D has been detected, a virtual connecting partial projection plane 33 connecting adjacent partial projection planes 32 is formed between these partial projection planes 32.

Specifically, in a case where the three-dimensional object sensor detects the three-dimensional object D in a certain azimuth range R (first azimuth range R) and does not detect the three-dimensional object D in another azimuth range R (second azimuth range R) adjacent to this azimuth range R, let us presume a situation in which the control unit 11 adjusts the distance L from the vehicle 1 of the rising position P of the partial projection plane 32 corresponding to the azimuth range R in which the three-dimensional object D has been detected depending on the three-dimensional object D. In this case, between the partial projection plane 32 (first partial projection plane) in the first azimuth range R and the partial projection plane 32 (second partial transparent plane) in the second azimuth range R, a virtual connecting partial projection plane 33 (fourth connecting partial projection plane) connecting the partial projection plane 32 (first partial projection plane) and the partial projection plane 32 (second partial projection plane) is formed.

For example, assume a case in which the three-dimensional object sensor detects the three-dimensional object D in the azimuth range Re and does not detect the three-dimensional object D in the azimuth range Rf adjacent to the azimuth range Re. In this case, as described above, the control unit 11 adjusts the distance Le from the vehicle 1 to the rising position Pe of the partial projection plane 32e corresponding to the azimuth range Re in such a manner as to be shorter than a distance Lf from the vehicle 1 to the rising position Pf of the partial projection plane 32f corresponding to the azimuth range Rf. Then, the control unit 11 adjusts a connecting plane connecting the partial projection plane 32e in the azimuth range Re of which rising position P has been adjusted and the partial projection plane 32f in the azimuth range Rf as a connecting partial projection plane 33e'. The connecting partial projection plane 33e' is an example of the connecting partial projection plane 33. The connecting partial projection plane 33 corresponds to an azimuth range R (fourth azimuth range) between azimuth ranges R corresponding to two partial projection planes 32 to be connected. Specifically, the connecting partial projection plane 33e' is the connecting partial projection plane 33 corresponding to the azimuth range Re' between the azimuth range Re and the azimuth range Rf corresponding to the partial projection plane 32e and the partial projection plane 32f, respectively, connected by the connecting partial projection plane 33e'. The connecting partial projection plane 33 constitutes part of the projection plane 30.

Through these types of processing, the control unit 11 adjusts the rising positions P of the partial projection planes 32 corresponding to the respective azimuth ranges R depending on whether or not the three-dimensional object D is detected in a corresponding azimuth range R and the distance from the vehicle 1 to the three-dimensional object D. Furthermore, the control unit 11 sets the connecting partial projection plane 33 depending on the adjustment of the rising positions P of the partial projection planes 32.

With the control unit 11 adjusting the rising position P of a partial projection plane 32 depending on the three-dimensional object D in the corresponding azimuth range R, the difference between the distance L from the rising position P of the partial projection plane 32 to the vehicle 1 and the distance L from the rising position P of the partial projection plane 32 corresponding to another azimuth range R adjacent to this azimuth range R to the vehicle 1 may increase. Moreover, as the difference of the distance L is larger, distortion may occur in the display video generated by projecting the peripheral video captured by the camera 16 onto the adjusted projection plane 30.

Therefore, preferably, the control unit 11 further executes the following processing after adjusting the rising position P of each of the partial projection planes 32 corresponding to one of the azimuth ranges R depending on whether or not the three-dimensional object D is detected in the corresponding azimuth range R and the distance from the vehicle 1 to the three-dimensional object D.

Specifically, the control unit 11 adjusts the distance L (fifth distance) from the vehicle 1 to a rising position P (fifth rising position) of a virtual partial projection plane 32 (fifth partial projection plane) corresponding to an azimuth range R (fifth azimuth range) between the partial projection plane 32 (first partial projection plane) corresponding to the azimuth range R (first azimuth range R) in which the three-dimensional object D has been detected and the partial projection plane 32 (second partial projection plane) corresponding to the azimuth range R (second azimuth range R) in which the three-dimensional object D is not detected, to be longer than the distance L (first distance) of the first partial projection plane and smaller than the distance L (second distance) of the second partial projection plane.

In addition, in a case where the difference between the distance L (first distance) between the rising position P (first rising position) of the first partial projection plane and the vehicle 1 and the distance L (second distance) between the rising position P (second rising position) of the second partial projection plane and the vehicle 1 is greater than a predetermined value, the control unit 11 adjusts, between these azimuth ranges R, a partial projection plane 32 (fifth partial projection plane) in which the distance L (fifth distance) to the rising position P (fifth rising position) from the vehicle 1 is longer than the first distance and shorter than the second distance.

The predetermined value may be set in advance. The predetermined value may be modified as appropriate in accordance with an operation instruction or the like by the user.

Specifically, for example, assume a case in which the three-dimensional object sensor detects the three-dimensional object D in the azimuth range Re and does not detect the three-dimensional object D in the azimuth range Rf and the azimuth range Rg adjacent to the azimuth range Re. In this case, as described above, the control unit 11 adjusts the distance Le from the vehicle 1 to the rising position Pe of the partial projection plane 32e corresponding to the azimuth range Re in such a manner as to be shorter than a distance Lf from the vehicle 1 to the rising position Pf of the partial projection plane 32f corresponding to each of the azimuth range Rf and the azimuth range Rg and to be shorter than a distance Lg from the vehicle 1 to the rising position Pg of the partial projection plane 32 g. Then, assume a case in which a difference between the distance Le from the vehicle 1 to the rising position Pe of the partial projection plane 32e corresponding to the azimuth range Re after the adjustment and the distance Lg from the vehicle 1 to the rising position Pg of the partial projection plane 32 g corresponding to the azimuth range Rg is greater than the predetermined value. In this case, the control unit 11 further adjusts the distance Lf from the vehicle 1 to the rising position Pf of the partial projection plane 32f corresponding to the azimuth range Rf between the azimuth range Re and the azimuth range Rg to be longer than the distance Le from the vehicle 1 to the rising position Pe of the partial projection plane 32e corresponding to the azimuth range Re and shorter than the distance Lg from the vehicle 1 to the rising position Pg of the partial projection plane 32g corresponding to the azimuth range Rg.

Specifically, the control unit 11 further executes the following processing after adjusting the rising position P of each of the partial projection planes 32 corresponding to one of the azimuth ranges R depending on whether or not the three-dimensional object D is detected in the corresponding azimuth range R and the distance from the vehicle 1 to the three-dimensional object D.

First, the control unit 11 sets an unprocessed item flag for all the azimuth ranges R. Then, the control unit 11 specifies, as a processing target, one azimuth range R having the shortest distance L from the vehicle 1 to the rising position P among the unprocessed azimuth ranges R.

The control unit 11 determines whether or not the difference between the distance L from the vehicle 1 to the rising position P of the partial projection plane 32 corresponding to the azimuth range R specified as a processing target and the distance L from the vehicle 1 to the rising position P of the partial projection plane 32 corresponding to another azimuth range R adjacent to this azimuth range R is greater than or equal to the predetermined value. In a case where the difference is greater than or equal to the predetermined value, the control unit 11 adjusts the distance L from the vehicle 1 to the rising position P of the partial projection plane 32 corresponding to the azimuth range R specified as a processing target to be longer than the current distance L and shorter than the distance L from the vehicle 1 to the rising position P of the partial projection plane 32 corresponding to the other adjacent azimuth range R. In a case where the difference is less than the predetermined value, the control unit 11 does not perform the adjustment processing of the distance L.

Then, the control unit 11 sets a processed item flag to the azimuth range R having been specified as the processing target. Then, the control unit 11 repeatedly executes these types of processing until the processed item flag is set for all the azimuth ranges R.

With these types of processing, the control unit 11 adjusts the distance L (fifth distance) from the vehicle 1 to a rising position P (fifth rising position) of a virtual partial projection plane 32 (fifth partial projection plane) corresponding to an azimuth range R (fifth azimuth range) between the partial projection plane 32 (first partial projection plane) corresponding to the azimuth range R (first azimuth range R) in which the three-dimensional object D has been detected and the partial projection plane 32 (second partial projection plane) corresponding to the azimuth range R (second azimuth range R) in which the three-dimensional object D is not detected, to be longer than the distance L (first distance) of the first partial projection plane and smaller than the distance L (second distance) of the second partial projection plane.

Therefore, the control unit 11 can suppress the display video generated by projecting the peripheral video captured by the camera 16 on the adjusted projection plane 30 from including distortion.

By the adjustment processing by the control unit 11, for example, the projection plane 30 is adjusted which includes the road surface projection plane 31 illustrated in FIG. 5, the partial projection planes 32 each corresponding to one of mutually different azimuth ranges R, and the connecting partial projection plane 33. In addition, as described above, for each of the cameras 16 provided in the vehicle 1, the control unit 11 executes the adjustment processing in a similar manner to the above for the substantially fan-shaped virtual road surface projection plane 31 centered on the camera 16 and a partial projection plane 32 rising from a rising position P of the road surface projection plane 31 for each of the different azimuth ranges R. Through these types of processing, the control unit 11 adjusts the projection plane 30 including the partial projection planes 32 and the one or more connecting partial projection planes 33 in mutually different azimuth ranges R virtually surrounding the periphery of the vehicle 1 with the vehicle 1 as the center of the road surface projection plane 31.

Then, the control unit 11 causes the display device 22 to display a display video converted to be projected onto the projection plane 30 based on a peripheral video acquired by at least one camera 16.

Specifically, after adjusting the rising position P of each of the partial projection planes 32 corresponding to one of the azimuth ranges R depending on whether or not the three-dimensional object D is detected in the corresponding azimuth range R and the distance from the vehicle 1 to the three-dimensional object D, the control unit 11 further projects the peripheral video obtained by the at least one camera 16 onto the projection plane 30 adjusted by executing the above processing for suppressing distortion of the display video. Thus, the control unit 11 causes the display device 22 to display the display video, which is a projection video obtained by projecting the peripheral video obtained by the at least one camera 16 onto the projection plane 30, as the overhead view video in the state where the vehicle 1 is photographed from above.

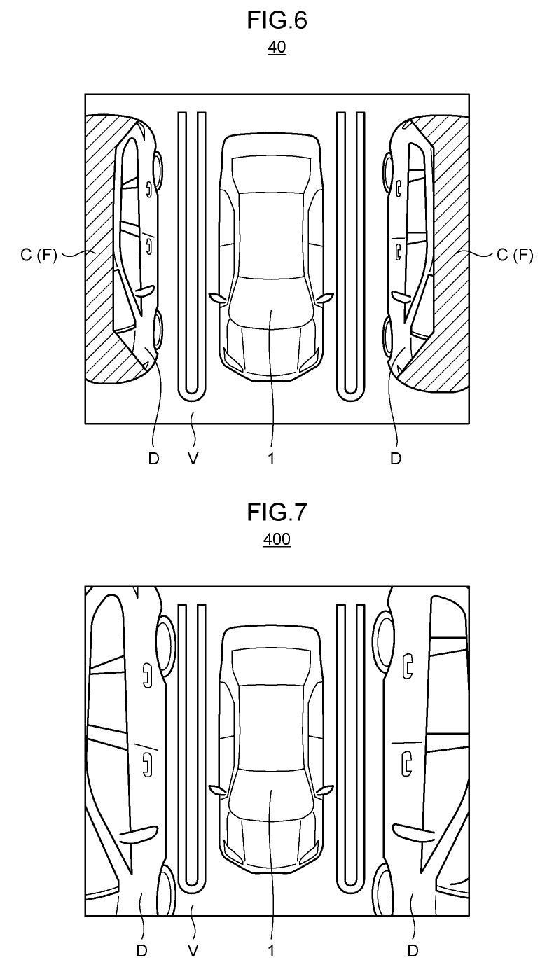

FIG. 6 is a schematic diagram of an example of a display video 40 displayed on the display device 22 by the vehicle control device 10 of the present embodiment.

FIG. 7 is a schematic diagram of an example of a conventional display video 400 by a conventional vehicle display control device.

As illustrated in FIG. 7, in the related art, the conventional display video 400, which is a composite video in which the three-dimensional object D present around the vehicle 1 is illustrated two-dimensionally, is displayed. For this reason, the conventional display video 400 is an unnatural display video in which a three-dimensional object D such as another vehicle present around the vehicle 1 is enlarged and displayed as compared with the actual relative size with respect to that of the vehicle 1.

On the other hand, in the vehicle control device 10 of the present embodiment, the control unit 11 causes the display device 22 to display the display video 40, which is a projection video obtained by projecting a peripheral video V captured by the vehicle 1 onto the projection plane 30 obtained by adjusting the rising position P of each of the partial projection planes 32 corresponding to one of the azimuth ranges R depending on whether or not the three-dimensional object D is detected in the corresponding azimuth range R.

For this reason, the three-dimensional object D around the vehicle 1 included in the display video 40 is suppressed from be enlarged, and thus the display video 40 of the present embodiment is closer to the state where the vehicle 1 is actually captured from above.

Note that the three-dimensional object D included in the display video 40 generated by projecting the peripheral video V captured by the camera 16 onto the projection plane 30 obtained by adjusting the rising position P of each of the partial projection planes 32 corresponding to one of the azimuth ranges R depending on whether or not the three-dimensional object D is detected in the corresponding azimuth range R may include a portion F not captured in the peripheral video V acquired by a camera 16 (see FIG. 6). In this case, the control unit 11 preferably complements the uncaptured portion F with a complementary image C. The control unit 11 is only required to generate and display the complementary image C by using known image processing technology or the like that complements the entire three-dimensional object D or an area beyond part of the three-dimensional object D captured in the peripheral video V from the part of the three-dimensional object D.

Next, an example of a procedure of information processing executed by the control unit 11 of the present embodiment will be described.

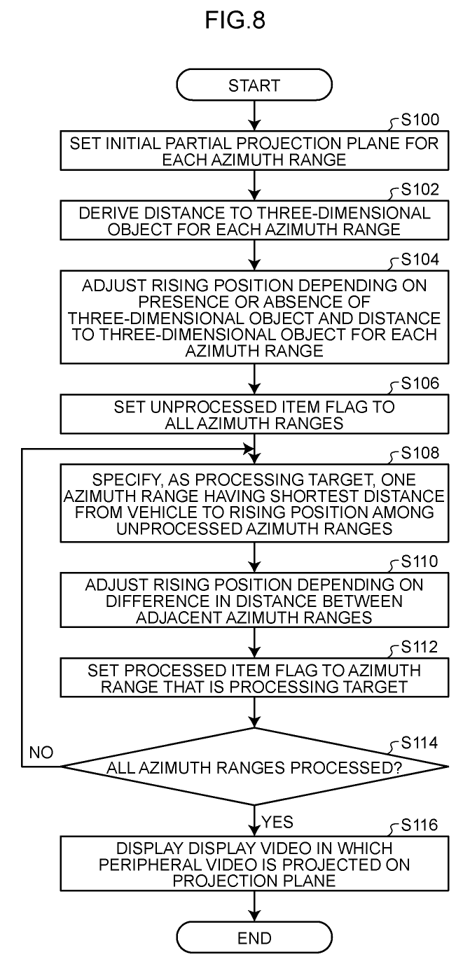

FIG. 8 is a flowchart illustrating an example of a procedure of information processing executed by the control unit 11.

For example, when power is supplied to each unit of devices of the vehicle 1, the control unit 11 repeatedly executes processing of steps S100 to S116 until the supply of power is interrupted.

The control unit 11 sets the initial partial projection plane 32 for each of the azimuth ranges R (step S100). Specifically, the control unit 11 sets, for each of the cameras 16 provided in the vehicle 1, the substantially fan-shaped virtual road surface projection plane 31 centered on the camera 16 and the virtual partial projection planes 32 each extending radially in a direction away from the vehicle 1 and rising from a rising position P, which is a position away from the camera 16 by a predetermined distance L (initial distance L0), for one of the azimuth ranges R having different azimuths.

Next, the control unit 11 determines whether or not the three-dimensional object D has been detected for each azimuth range R. Furthermore, the control unit 11 derives the distance from the vehicle 1 to the three-dimensional object D for an azimuth range R in which the three-dimensional object D has been detected (step S102).

Then, the control unit 11 adjusts the rising position P depending on whether or not the three-dimensional object D is detected and the distance from the vehicle 1 to the three-dimensional object D for each azimuth range R (step S104).

As described above, assume a case in which the control unit 11 detects the three-dimensional object D in a certain azimuth range R among the azimuth ranges R around the vehicle 1 and does not detect the three-dimensional object D in another azimuth range R different from this azimuth range R. In this case, the control unit 11 sets the distance L from the vehicle 1 to the rising position P of a partial projection plane 32 corresponding to the azimuth range R in which the three-dimensional object D has been detected to be shorter than the distance L from the vehicle 1 to the rising position P of a partial projection plane 32 corresponding to the other azimuth range R in which the three-dimensional object D is not detected.

Furthermore, in a case where the three-dimensional object D is detected in a certain azimuth range R and the three-dimensional object D is not detected in another azimuth range R different from this azimuth range R, the control unit 11 further adjusts the rising position P of the road surface projection plane 31 corresponding to the azimuth range R in which the three-dimensional object D has been detected to a position corresponding to the position of the detected three-dimensional object D.

Furthermore, with the control unit 11 adjusting the rising position P of the partial projection plane 32 corresponding to the azimuth range R in which the three-dimensional object D has been detected, a virtual connecting partial projection plane 33 connecting other partial projection planes 32 adjacent to this partial projection plane 32 is formed between these partial projection planes 32.

Through these types of processing, the control unit 11 adjusts the rising positions P of the partial projection planes 32 corresponding to the respective azimuth ranges R depending on whether or not the three-dimensional object D is detected in a corresponding azimuth range R and the distance from the vehicle 1 to the three-dimensional object D. In addition, the control unit 11 forms a connecting partial projection plane 33 between partial projection planes 32 of adjacent azimuth ranges R as necessary.

Next, the control unit 11 sets an unprocessed item flag for all the azimuth ranges R adjusted by the processing of steps S100 to S104 (step S106).

Then, the control unit 11 specifies, as a processing target, one azimuth range R having the shortest distance L from the vehicle 1 to the rising position P among the unprocessed azimuth ranges R (step S108).

The control unit 11 adjusts the rising position P of the processing target azimuth range R depending on a difference between the distance L from the vehicle 1 to the rising position P of the partial projection plane 32 corresponding to the azimuth range R specified as a processing target and the distance L from the vehicle 1 to the rising position P of the partial projection plane 32 corresponding to another azimuth range R adjacent to this azimuth range R (step S110).

Specifically, the control unit 11 determines whether or not the difference between the distance L from the vehicle 1 to the rising position P of the partial projection plane 32 corresponding to the azimuth range R specified as a processing target and the distance L from the vehicle 1 to the rising position P of the partial projection plane 32 corresponding to another azimuth range R adjacent to this azimuth range R is greater than or equal to the predetermined value. In a case where the difference is greater than or equal to the predetermined value, the control unit 11 adjusts the distance L from the vehicle 1 to the rising position P of the partial projection plane 32 corresponding to the azimuth range R specified as a processing target to be longer than the current distance L and shorter than the distance L from the vehicle 1 to the rising position P of the partial projection plane 32 corresponding to the other adjacent azimuth range R. In a case where the difference is less than the predetermined value, the control unit 11 does not perform the adjustment processing of the distance L.

Then, the control unit 11 sets a processed item flag to the azimuth range R having been specified as the processing target (step S112).

Next, the control unit 11 determines whether or not all the azimuth ranges R have been processed (step S114). The control unit 11 determines whether or not the processed item flag is set for all the azimuth ranges R, thereby making the determination of step S114. If a negative determination is made in step S114 (step S114: No), the process proceeds to step S108 described above. If an affirmative determination is made in step S114 (step S114: Yes), the process proceeds to step S116.

By executing the processing of steps S106 to S114, the control unit 11 adjusts the distance L (fifth distance) from the vehicle 1 to a rising position P (fifth rising position) of a virtual partial projection plane 32 (fifth partial projection plane) corresponding to an azimuth range R (fifth azimuth range) between the partial projection plane 32 (first partial projection plane) corresponding to the azimuth range R (first azimuth range R) in which the three-dimensional object D has been detected and the partial projection plane 32 (second partial projection plane) corresponding to the azimuth range R (second azimuth range R) in which the three-dimensional object D is not detected, to be longer than the distance L (first distance) of the first partial projection plane and smaller than the distance L (second distance) of the second partial projection plane.

In step S116, the display video 40, which is a projection video obtained by projecting the peripheral video obtained by at least one camera 16 onto the projection plane 30 adjusted by the processing of steps S100 to S114, is displayed on the display device 22 (step S116). Then, this routine is ended.

As described above, the vehicle control device 10 (vehicle display control device) of the present embodiment is provided in the vehicle 1 including at least one camera 16 that acquires a peripheral video V, the three-dimensional object sensor (sensor 14 or camera 16) that detects the three-dimensional object D around the vehicle 1, and the display device 22 that can be visually recognized by the passenger. The vehicle control device 10 sets the virtual projection plane 30 rising from a position away from the vehicle 1 by the predetermined distance L. The projection plane 30 includes at least the virtual first partial projection plane (partial projection plane 32) corresponding to the first azimuth range (azimuth range R) and rising from the first rising position (rising position P), and the virtual second partial projection plane (partial projection plane 32) corresponding to the second azimuth range (azimuth range R) and rising from the second rising position (rising position P). In a case where the three-dimensional object sensor detects the three-dimensional object D in the first azimuth range (azimuth range R) and does not detect the three-dimensional object D in the second azimuth range (azimuth range R), the vehicle control device 10 sets the first distance (distance L) to the first rising position (rising position P) of the first partial projection plane (partial projection plane 32) from the vehicle 1 to be smaller than the second distance (distance L) to the second rising position (rising position P) of the second partial projection plane (partial projection plane 32) from the vehicle 1. The vehicle control device 10 causes the display device 22 to display the display video 40 converted to be projected onto the projection plane 30 based on a peripheral video V acquired by at least one of the cameras 16.

Incidentally, in the related art, the conventional display video 400, which is a composite video in which the three-dimensional object D present around the vehicle 1 is illustrated two-dimensionally, is displayed (see FIG. 7). For this reason, the conventional display video 400 is an unnatural display video in which a three-dimensional object D such as another vehicle present around the vehicle 1 is enlarged and displayed as compared with the actual relative size with respect to that of the vehicle 1.

On the other hand, in the vehicle control device 10 of the present embodiment, the control unit 11 causes the display device 22 to display the display video 40, which is a projection video obtained by projecting the peripheral video V captured by the vehicle 1 onto the projection plane 30 obtained by adjusting the rising position P of each of the partial projection planes 32 corresponding to one of the azimuth ranges R depending on whether or not the three-dimensional object D is detected in the corresponding azimuth range R.

Therefore, in the display video 40, the three-dimensional object D around the vehicle 1 included therein is closer to the state where the vehicle 1 is actually photographed from above.

Therefore, the vehicle control device 10 (vehicle display control device) of the present embodiment can provide the display video 40 that is closer to the state where the vehicle 1 is photographed from above.

### Second Embodiment

In the present embodiment, a mode of displaying an overhead view video in which an angle-of-view area that is not included in the peripheral video V is complemented.

In the present embodiment, the same functions or configurations as those in the above embodiment are denoted by the same symbols, and detailed description thereof will be omitted.

FIG. 1 is a block diagram illustrating an example of an overall configuration of a vehicle 1B of the present embodiment.

The vehicle 1B is similar to the vehicle 1 of the above embodiment except that a vehicle control device 10B is included instead of the vehicle control device 10. The arrangement of sensors 14 and cameras 16 of the vehicle 1B of the present embodiment is also similar to that of the vehicle 1 of the above embodiment (see FIG. 2). The appearance of the vehicle 1B of the present embodiment and the configuration in the vicinity of the driver's seat are also similar to those of the vehicle 1 of the above embodiment (see FIGS. 3 and 4).

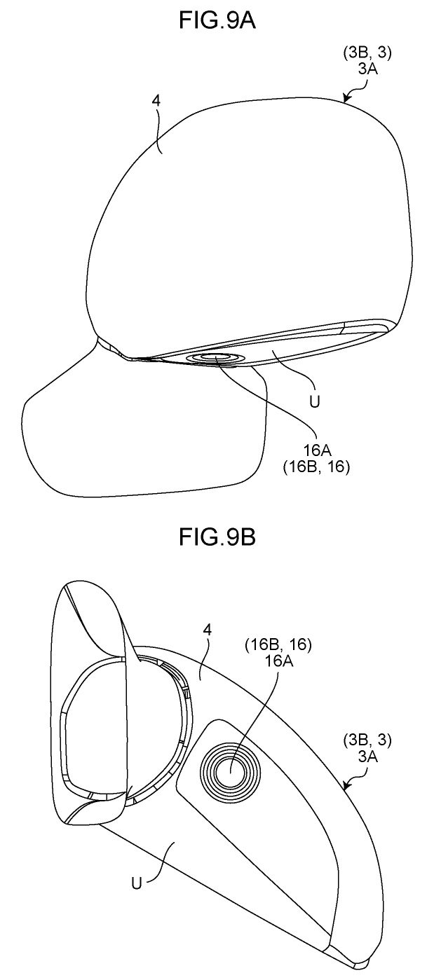

FIGS. 9A and 9B are detailed explanatory diagrams of an example of arrangement of the cameras 16. FIGS. 9A and 9B illustrate an example of detailed arrangement of a first camera 16A that is disposed on the left side of the vehicle 1 and captures an image of the left side of the vehicle 1 and a second camera 16B that is disposed on the right side of the vehicle 1 and captures an image of the right side of the vehicle 1.

The first camera 16A and the second camera 16B are each attached to a lower surface U of a housing 4 of a door mirror 3 attached to the vehicle 1B. The door mirror 3 may be referred to as a side mirror. In the vehicle 1B, a left side door mirror 3A used for a passenger to check the left side of the vehicle 1B and a right side door mirror 3B used for the passenger to check the right side of the vehicle 1B are attached as door mirrors 3. The first camera 16A is attached to a lower surface U of a housing 4 of the left side door mirror 3A, and the second camera 16B is attached to a lower surface U of a housing 4 of the right side door mirror 3B.

Returning to FIG. 1, the description will be continued.

The vehicle control device 10B is an electronic control unit that integrally controls the units of the vehicle 1B. The vehicle control device 10B is an example of the vehicle display control device. Moreover, a vehicle control method executed by the vehicle control device 10B is an example of the vehicle display control method.

Similarly to the vehicle control device 10, the vehicle control device 10B controls the travel control device 12 such that the traveling state of the vehicle 1B is optimized by using sensor information, peripheral videos V, and the like received from the sensors 14 and the cameras 16, respectively. In addition, the vehicle control device 10B controls the travel control device 12 to cause the vehicle 1B to autonomously travel.

The vehicle control device 10B includes a control unit 11B. A part or all of the control unit 11B may be configured as software implemented by cooperation of a processor and various programs stored in a memory. In addition, a part or all of the control unit 11B may be configured as hardware implemented by a dedicated circuit or the like.

The control unit 11B integrally controls the units of the vehicle 1B.

Similarly to the control unit 11, the control unit 11B causes the display device 22 to display a projection video obtained by converting the peripheral video V obtained by at least one camera 16 in such a manner as to project the peripheral video V onto the projection plane 30. In other words, the control unit 11B causes the display device 22 to display a projection video obtained by projecting the peripheral video V obtained by the camera 16 onto the projection plane 30 as an overhead view video in the state where the vehicle 1 is photographed from above.

Incidentally, since the cameras 16 are provided in the vehicle 1B, the peripheral video V acquired by a camera 16 has an angle of view of a range on a low altitude side, which is a road surface side with respect to an attachment position of the camera 16 to the vehicle 1. Therefore, the peripheral video V may not include at least part of the top face of the three-dimensional object D or the like around the vehicle 1B. Therefore, the projection video projected on the projection plane 30 without complementing the peripheral video V obtained by the cameras 16 may lack part of the angle of view obtained by capturing the vehicle 1B from an overhead viewpoint above the vehicle 1B.

Therefore, the control unit 11B of the present embodiment causes the display device 22 to display the overhead view video in which an angle-of-view area that is not included in the peripheral video V is complemented.

Hereinafter, vehicle display control by the control unit 11B will be described in detail.

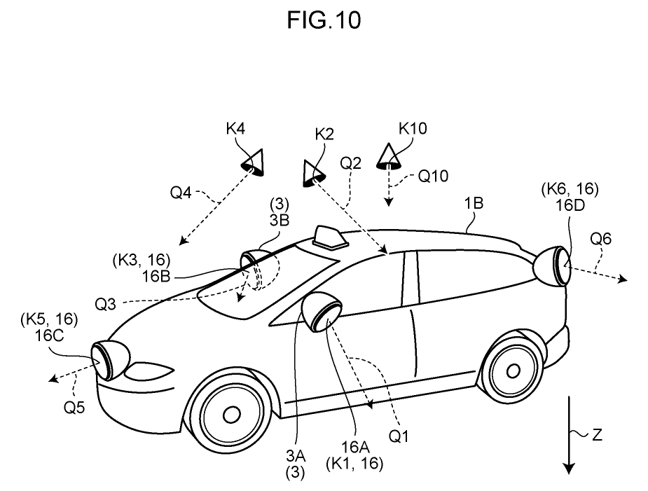

FIG. 10 is an explanatory diagram of an example of vehicle display control by the vehicle control device 10 of the present embodiment.

First, viewpoints K, capturing directions Q, and obtained peripheral videos V of the cameras 16 provided in the vehicle 1B will be described in detail.

The first camera 16A acquires a first peripheral video V1 in a first direction Q1 from a first viewpoint K1. The first viewpoint K1 corresponds to the installation position of the first camera 16A. Specifically, as described above, since the first camera 16A is provided on the lower surface U of the left side door mirror 3A, the first viewpoint K1 is at a position corresponding to the lower surface U of the left side door mirror 3A. The first direction Q1 is an imaging direction of the first camera 16A. The first peripheral video V1 is a peripheral video V acquired by the first camera 16A.

The second camera 16B acquires a third peripheral video V3 in a third direction Q3 from a third viewpoint K3. The third viewpoint K3 corresponds to the installation position of the second camera 16B. Specifically, as described above, since the second camera 16B is provided on the lower surface U of the right side door mirror 3B, the third viewpoint K3 is at a position corresponding to the lower surface U of the right side door mirror 3B. The third direction Q3 is an imaging direction of the second camera 16B. The third peripheral video V3 is a peripheral video V acquired by the second camera 16B. The third viewpoint K3 and the first viewpoint K1 are preferably at the same height. In the present embodiment, a case where the third viewpoint K3 and the first viewpoint K1 are at the same height will be described as an example.

The third camera 16C acquires a fifth peripheral video V5 in a fifth direction Q5 from a fifth viewpoint K5. The fifth viewpoint K5 corresponds to the installation position of the third camera 16C. The fifth direction Q5 is an imaging direction of the third camera 16C. The fifth peripheral video V5 is a peripheral video V acquired by the third camera 16C.

The fourth camera 16D acquires a sixth peripheral video V6 in a sixth direction Q6 from a sixth viewpoint K6. The sixth viewpoint K6 corresponds to the installation position of the fourth camera 16D. The sixth direction Q6 is an imaging direction of the fourth camera 16D. The sixth peripheral video V6 is a peripheral video V acquired by the fourth camera 16D.

Note that the first viewpoint K1 of the first camera 16A, the second viewpoint K2 of the second camera 16B, the fifth viewpoint K5 of the third camera 16C, and the sixth viewpoint K6 of the fourth camera 16D may have the same or different heights from the traveling path of the vehicle 1B. In the present embodiment, a mode in which the first viewpoint K1 of the first camera 16A, the second viewpoint K2 of the second camera 16B, the fifth viewpoint K5 of the third camera 16C, and the sixth viewpoint K6 of the fourth camera 16D have the same height from the traveling path of the vehicle 1B will be described as an example.

The control unit 11B generates a second peripheral video V2 in the second direction Q2 from the second viewpoint K2 at a position higher than the first viewpoint K1 by using the learning model based on the first peripheral video V1.

Specifically, the control unit 11B generates the second peripheral video V2 in which the second direction Q2 is captured from the second viewpoint K2 at a position higher than the first viewpoint K1 from the first peripheral video V1 in the first direction Q1 captured from the first viewpoint K1 by the first camera 16A.

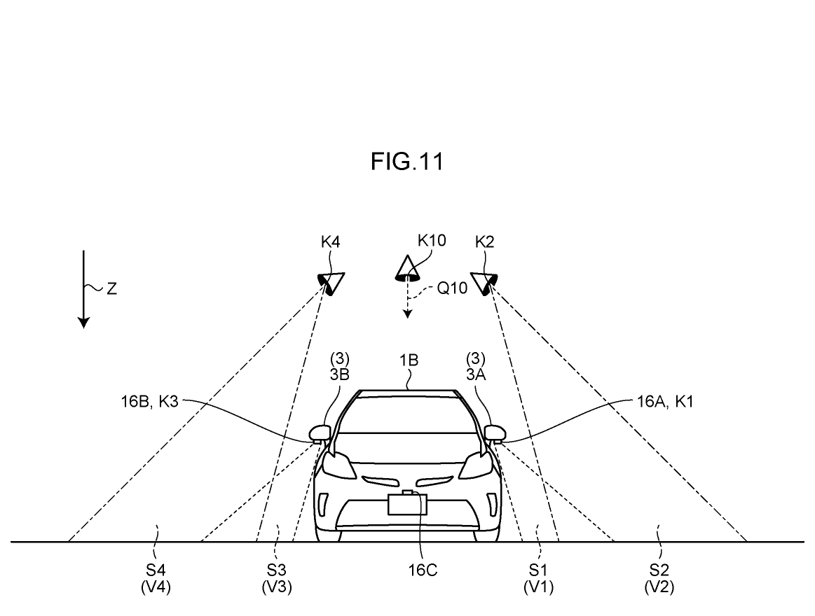

FIG. 11 is an explanatory diagram illustrating an example of the positional relationship among the first viewpoint K1, the second viewpoint K2, the third viewpoint K3, and the fourth viewpoint K4.

The second viewpoint K2 is only required to be a position higher than the first viewpoint K1. Specifically, the second viewpoint K2 is higher than the first viewpoint K1 and is equal to or lower than an overhead viewpoint K10 which is a viewpoint of an overhead view video 50 to be described later.

The first direction Q1, which is the imaging direction of the first camera 16A, and the second direction Q2 of the second viewpoint K2 are different. Specifically, the first direction Q1 is closer to a vertical direction Z than the second direction Q2 is (see also FIG. 10).

Therefore, a second angle of view S2 of the second peripheral video V2 is obtained by setting a position higher than a first angle of view S1 of the first peripheral video V1 as the second viewpoint K2 and photographing the periphery of the vehicle 1B in a direction having a larger inclination with respect to the vertical direction Z from the second viewpoint K2. In addition, at least part of the second angle of view S2 of the second peripheral video V2 does not overlap with the first angle of view S1 of the first peripheral video V1. Thus, the second peripheral video V2 is a peripheral video V obtained by complementing the first peripheral video V1 for an out-of-angle-of-view area from the first angle of view S1 in the first peripheral video V1.

Referring back to FIG. 10, the description will be continued.

The control unit 11B further generates a fourth peripheral video V4 in a fourth direction Q4 from the fourth viewpoint K4 at a position higher than the third viewpoint K3 by using the learning model based on the third peripheral video V3.

Specifically, the control unit 11B generates the fourth peripheral video V4 in which the fourth direction Q4 is captured from the fourth viewpoint K4 at a position higher than the third viewpoint K3 from the third peripheral video V3 in the third direction Q3 captured from the third viewpoint K3 by the second camera 16B.

The fourth viewpoint K4 is only required to be a position higher than the third viewpoint K3. Specifically, the fourth viewpoint K4 is higher than the third viewpoint K3 and is equal to or lower than the overhead viewpoint K10 which is the viewpoint of the overhead view video 50 to be described later. Moreover, the fourth viewpoint K4 and the second viewpoint K2 preferably have the same height. In the present embodiment, a case where the fourth viewpoint K4 and the second viewpoint K2 are at the same height will be described as an example.

The third direction Q3, which is the imaging direction of the second camera 16B, is different from the fourth direction Q4 of the fourth viewpoint K4. Specifically, the third direction Q3 is closer to the vertical direction Z than the fourth direction Q4 is.

Therefore, as illustrated in FIG. 11, a fourth angle of view S4 of the fourth peripheral video V4 is obtained by setting a position higher than the third angle of view S3 of the third peripheral video V3 as the fourth viewpoint K4 and photographing the periphery of the vehicle 1B in a direction having a larger inclination with respect to the vertical direction Z from the fourth viewpoint K4. In addition, at least part of the fourth angle of view S4 of the fourth peripheral video V4 does not overlap with the third angle of view S3 of the third peripheral video V3. Thus, the fourth peripheral video V4 is a peripheral video V obtained by complementing the third peripheral video V3 for an out-of-angle-of-view area from the third angle of view S3 in the third peripheral video V3.

Returning to FIG. 10, the description will be continued. The inclination values of the first direction Q1 and the third direction Q3 with respect to the vertical direction Z may be the same or different except for a case where the inclination directions with respect to the vertical direction Z are different. Likewise, the inclination values of the second direction Q2 and the fourth direction Q4 with respect to the vertical direction Z may be the same or different except for a case where the inclination directions with respect to the vertical direction Z are different.

The control unit 11B generates the second peripheral video V2 from the first peripheral video V1 and generates the fourth peripheral video V4 from the third peripheral video V3 by using the learning model.

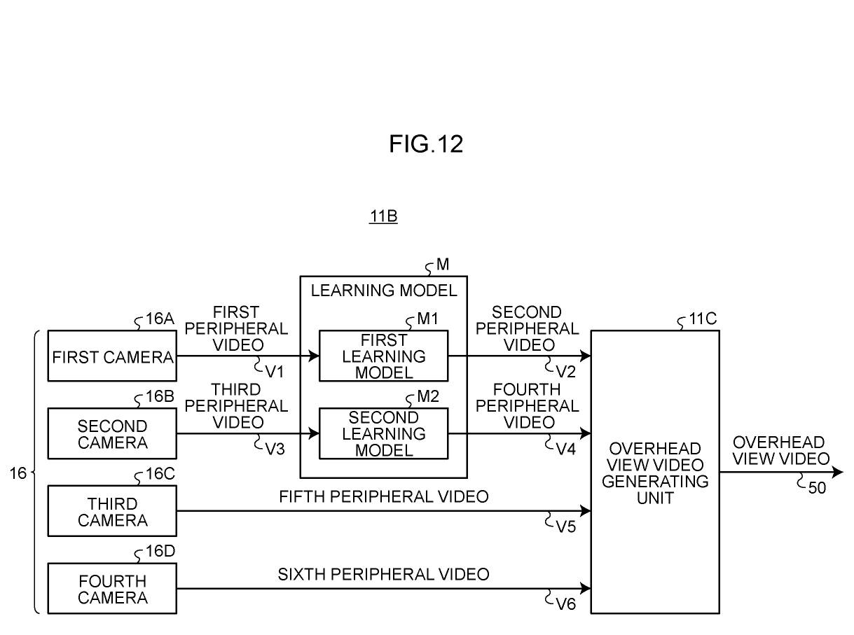

FIG. 12 is an explanatory diagram of an example of processing using a learning model M by the control unit 11B.

The learning model M includes a first learning model M1 and a second learning model M2.

The first learning model M1 is a machine learning model which receives the first peripheral video V1 as input and the second peripheral video V2 as output. Examples of the machine learning model include a known convolutional neural network and the like, but are not limited thereto.

The first learning model M1 is the learning model M trained based on a first training video acquired by a first learning camera having the first direction Q1 as the imaging direction at the first viewpoint K1 and a second training video acquired by a second learning camera having the second direction Q2 as the imaging direction at the second viewpoint K2.

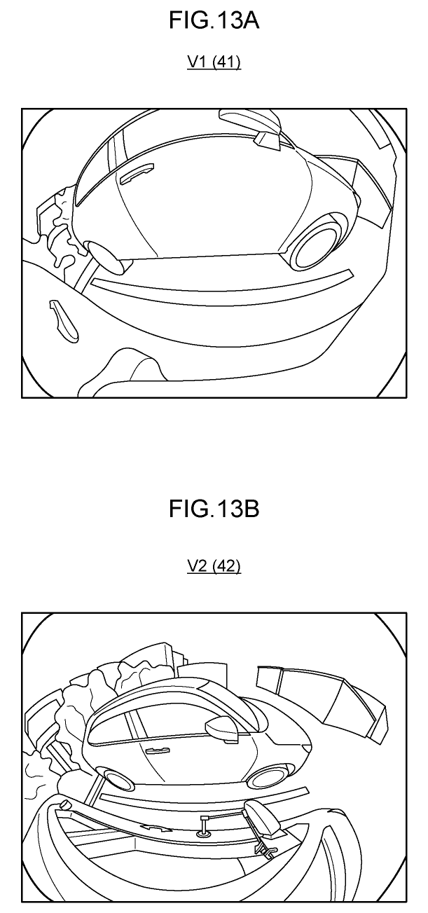

FIG. 13A is a schematic diagram of an example of a first training video 41. FIG. 13B is a schematic diagram of an example of a second training video 42.

For example, the control unit 11B uses, as the first learning camera, the first camera 16A that captures the first direction Q1 from the first viewpoint K1 of the vehicle 1B. In addition, a camera, which is installed at the second viewpoint K2 at a position higher than the first viewpoint K1 with respect to the first viewpoint K1 of the first camera 16A of the vehicle 1B and captures a video in the second direction Q2 from the second viewpoint K2, is used as the second learning camera. Then, a pair of the first training video 41 captured by the first learning camera at certain timing and the second training video 42 captured by the second learning camera at the certain timing is used as one teacher training data. Then, pieces of teacher training data, which are a group of the pairs acquired at different timings in time series, are prepared in advance. The control unit 11B is only required to train the first learning model M1 in advance by a known method using these groups of teacher training data in such a manner that the first training video 41 included in each piece of teacher training data is received as input and that the second training video 42 corresponding to the first training video 41 is output. Note that the training of the first learning model M1 may be executed by an information processing device or the like provided outside the vehicle 1B. The control unit 11B is only required to store the trained first learning model M1 in advance.

Returning to FIG. 12, the description will be continued.

The second learning model M2 is a machine learning model which receives the third peripheral video V3 as input and the fourth peripheral video V4 as output. Examples of the machine learning model include a known convolutional neural network, but are not limited thereto.

The second learning model M2 is the learning model M trained based on a third training video acquired by a third learning camera having the third direction Q3 as the imaging direction at the third viewpoint K3 and a fourth training video acquired by a fourth learning camera having the fourth direction Q4 as the imaging direction at the fourth viewpoint K4.

The control unit 11B uses the second camera 16B that captures the third direction Q3 from the third viewpoint K3 of the vehicle 1B as the third learning camera. In addition, a camera, which is installed at the fourth viewpoint K4 at a position higher than the third viewpoint K3 with respect to the third viewpoint K3 of the second camera 16B of the vehicle 1B and captures a video in the fourth direction Q4 from the fourth viewpoint K4, is used as the fourth learning camera. Then, a pair of the third training video captured by the third learning camera at certain timing and the fourth training video captured by the fourth learning camera at the certain timing is used as one piece of teacher training data. Then, pieces of teacher training data, which are a group of the pairs acquired at different timings in time series, are prepared in advance. The control unit 11B is only required to train the second learning model M2 in advance by a known method using these groups of teacher training data in such a manner that the third training video included in each piece of teacher training data is received as input and that the fourth training video corresponding to the third training video is output. Note that the training of the second learning model M2 may be executed by an information processing device or the like provided outside the vehicle 1B. The control unit 11B is only required to store the trained second learning model M2 in advance.

Then, based on the first peripheral video V1, the control unit 11B generates the second peripheral video V2 in the second direction Q2 from the second viewpoint K2 at a position higher than the first viewpoint K1 by using the first learning model M1. In other words, the control unit 11B generates the second peripheral video V2 from the first peripheral video V1 by inputting the first peripheral video V1 into the first learning model M1 and acquiring the second peripheral video V2 output from the first learning model M1.

Furthermore, based on the third peripheral video V3, the control unit 11B generates the fourth peripheral video V4 in the fourth direction Q4 from the fourth viewpoint K4 at a position higher than the third viewpoint K3 by using the second learning model M2. In other words, the control unit 11B generates the fourth peripheral video V4 from the third peripheral video V3 by inputting the third peripheral video V3 to the second learning model M2 and acquiring the fourth peripheral video V4 output from the second learning model M2.

Note that the first learning model M1 and the second learning model M2 may be the same learning model M.

In this case, the control unit 11B is only required to train the learning model M in advance by using the first teacher training data and the second teacher training data. The first teacher training data is a pair of the first training video 41 captured by the first learning camera at certain timing and the second training video 42 captured by the second learning camera at the certain timing. The second teacher training data is a pair of the third training video captured by the third learning camera at certain timing and the fourth training video captured by the fourth learning camera at the same timing. The control unit 11B is only required to train the learning model M in advance similarly to the above in such a manner that the first training video is received as input, that the second training video corresponding to the first training video is output, that the third training video is received as input, and that the fourth training video corresponding to the third training video is output by using pieces of first teacher training data and pieces of second teacher training data. Furthermore, the control unit 11B may acquire and store the learning model M trained by an external information processing device or the like.

With the control unit 11B using one learning model M as the first learning model M1 and the second learning model M2, the storage area of the control unit 11B and the processing load can be reduced. Moreover, even in a case where the processing capability of the control unit 11B is low, the control unit 11B can generate the second peripheral video V2 from the first peripheral video V1 and can generate the fourth peripheral video V4 from the third peripheral video V3.

Then, an overhead view video generating unit 11C included in the control unit 11B causes the display device 22 to display an overhead view video viewed from an overhead viewpoint higher than the first viewpoint K1 by using the second peripheral video V2.

This will be described with reference to FIG. 10.

The overhead view video is a video looking down on the vehicle 1B from the overhead viewpoint K10 higher than the first viewpoint K1. Specifically, the overhead view video shows the state where the vehicle 1B is looked down in a looking-down direction Q10 from the overhead viewpoint K10. The looking-down direction Q10 is closer to the vertical direction Z than the first direction Q1, the second direction Q2, the third direction Q3, the fourth direction Q4, the fifth direction Q5, and the sixth direction Q6 are.

The height of the overhead viewpoint K10 is equal to the height of the second viewpoint K2 or higher than the height of the second viewpoint K2. Similarly, the height of the overhead viewpoint K10 is equal to the height of the fourth viewpoint K4 or higher than the height of the fourth viewpoint K4.

The overhead view video generating unit 11C of the control unit 11B generates the overhead view video by using at least the second peripheral video V2.

In the present embodiment, the control unit 11 sets a projection video, obtained by projecting at least the second peripheral video V2 onto the projection plane, as the overhead view video 50 in the state where the vehicle 1 is photographed in the looking-down direction Q10 from the overhead viewpoint K10 and causes the display device 22 to display the overhead view video 50.

As described in the above embodiment, the projection plane is an image projection plane virtually disposed in a virtual space corresponding to the real space.

The control unit 11B generates the overhead view video 50 by projecting at least the second peripheral video V2 onto the projection plane 30 adjusted in accordance with the first embodiment. Furthermore, the control unit 11B may use a projection plane generated by a known method as the projection plane. However, from the viewpoint of generating the overhead view video 50 closer to the state where the vehicle 1B is photographed from above, the control unit 11B preferably projects the second peripheral video V2 onto the projection plane 30 adjusted in accordance with the first embodiment.

In addition, the control unit 11B may cause the display device 22 to display the overhead view video 50 looking down in the direction Q10 looking down on the vehicle 1B from the overhead viewpoint K10 higher than the first viewpoint K1 or the third viewpoint K3 by using the second peripheral video V2 and the fourth peripheral video V4.

In this case, the control unit 11B is only required to cause the display device 22 to display, as the overhead view video 50, a projection video obtained by projecting the second peripheral video V2 and the fourth peripheral video V4 onto the projection plane 30.

In addition, the control unit 11B may cause the display device 22 to display the overhead view video 50 looking down in the direction Q10 looking down on the vehicle 1B from the overhead viewpoint K10 by using the second peripheral video V2, the fourth peripheral video V4, the fifth peripheral video V5, and the sixth peripheral video V6.

In this case, the control unit 11B is only required to cause the display device 22 to display, as the overhead view video 50, a projection video obtained by projecting the second peripheral video V2, the fourth peripheral video V4, the fifth peripheral video V5, and the sixth peripheral video V6 onto the projection plane 30.

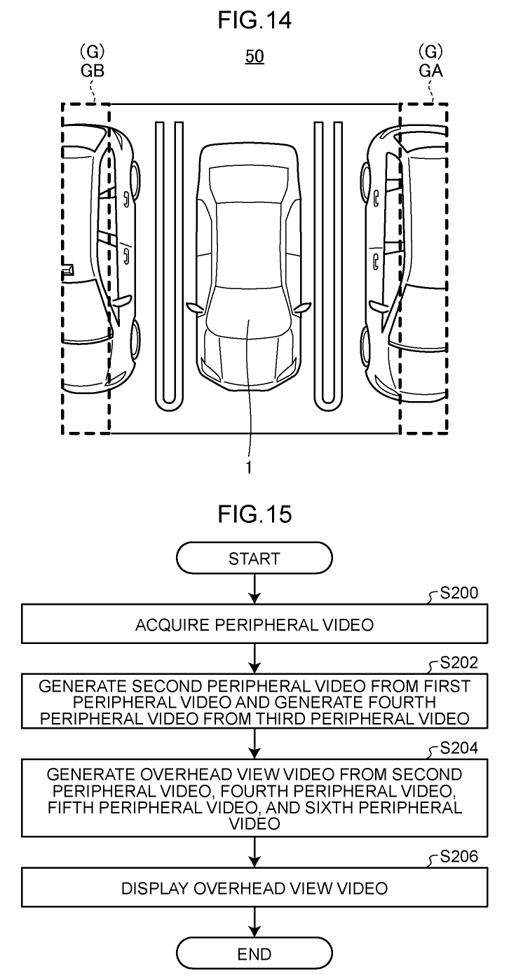

FIG. 14 is a schematic diagram of an example of the overhead view video 50 of the present embodiment.

With the control unit 11B causing the display device 22 to display the overhead view video 50, for example, the overhead view video 50 illustrated in FIG. 14 is displayed on the display device 22.

The overhead view video 50 is a projection video obtained by projecting the second peripheral video V2, the fourth peripheral video V4, the fifth peripheral video V5, and the sixth peripheral video V6 onto the projection plane 30. Therefore, the overhead view video 50 is a video in which an out-of-angle-of-view area GA of the first angle of view S1 of the first peripheral video V1 and an out-of-angle-of-view area GB of the third angle of view S3 of the third peripheral video V3 are compensated for.

Therefore, the vehicle control device 10B of the present embodiment can display, on the display device 22, the overhead view video 50 in which the angle of view is suppressed from being partially missing.

Next, a procedure of information processing executed by the control unit 11B of the present embodiment will be described.

FIG. 15 is a flowchart illustrating an example of a procedure of information processing executed by the control unit 11B of the present embodiment.

For example, when power is supplied to each unit of devices of the vehicle 1B, the control unit 11B repeatedly executes processing of steps S200 to S206 until the supply of power is interrupted.

The control unit 11 acquires peripheral videos V from the cameras 16 (step S200). The control unit 11B acquires the first peripheral video V1 from the first camera 16A and acquires the third peripheral video V3 from the second camera 16B. The control unit 11B also acquires the fifth peripheral video V5 from the third camera 16C and acquires the sixth peripheral video V6 from the fourth camera 16D.

The control unit 11B generates the second peripheral video V2 and the fourth peripheral video V4 by using the learning model M based on each of the first peripheral video V1 and the third peripheral video V3 (step S202). The control unit 11B inputs the first peripheral video V1 to the first learning model M1, and acquires the second peripheral video V2 output from the first learning model M1, thereby generating the second peripheral video V2 from the first peripheral video V1. Furthermore, the control unit 11B inputs the third peripheral video V3 to the second learning model M2 and acquires the fourth peripheral video V4 output from the second learning model M2, thereby generating the fourth peripheral video V4 from the third peripheral video V3.

The control unit 11B generates, as the overhead view video 50, a projection video obtained by projecting the second peripheral video V2 and the fourth peripheral video V4 generated in step S202 and the fifth peripheral video V5 and the sixth peripheral video V6 acquired in step S200 onto the projection plane 30 (step S204). Then, the control unit 11B causes the display device 22 to display the overhead view video 50 generated in step S206 (step S206). Then, this routine is ended.

As described above, the vehicle control device 10B (vehicle display control device) according to the embodiment is provided in the vehicle 1B including: the camera 16 (first camera 16A) that acquires the first peripheral video V1 in the first direction Q1 from the first viewpoint K1; and the display device 22 visually recognizable by a passenger. The vehicle control device 10B generates the second peripheral video V2 in the second direction Q2 from the second viewpoint K2 at a position higher than the first viewpoint K1 by using the learning model M based on the first peripheral video V1. The vehicle control device 10B causes the display device 22 to display the overhead view video 50 viewed from the overhead viewpoint K10 higher than the first viewpoint K1 by using the second peripheral video V2. The learning model M is trained based on the first training video 41 acquired by the first learning camera in the first direction Q1 at the first viewpoint K1 and the second training video 42 acquired by the second learning camera in the second direction Q2 at the second viewpoint K2.

As described above, in the vehicle control device 10B of the present embodiment, the second peripheral video V2 is generated in which the second direction Q2 is the imaging direction from the second viewpoint K2 at a position higher than the first viewpoint K1 of the first peripheral video V1. Then, the vehicle control device 10B causes the display device 22 to display the overhead view video 50 viewed from the overhead viewpoint K10 higher than the first viewpoint K1 by using the second peripheral video V2.

The second peripheral video V2 is a peripheral video illustrating the state where the second direction Q2 is captured from second viewpoint K2 higher than the first viewpoint K1 of the first peripheral video V1. Therefore, with the vehicle control device 10B causing the display device 22 to display the overhead view video 50 generated by using the second peripheral video V2, the video obtained by complementing the out-of-angle-of-view area GA of the first angle of view S1 of the first peripheral video V1 is displayed as the overhead view video 50 on the display device 22.

Therefore, in the vehicle control device 10B of the present embodiment, the overhead view video 50 (display video), in which the angle of view obtained by virtually capturing the vehicle 1B from the overhead viewpoint K10 is suppressed from being partially missing, can be displayed on the display device 22.

Therefore, the vehicle control device 10B of the present embodiment can provide the overhead view video 50 (display video) closer to the state where the vehicle 1B is photographed from above.

Next, the hardware configuration of the vehicle control device 10 and the vehicle control device 10B will be described.

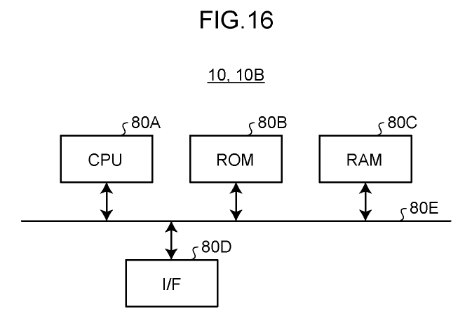

FIG. 16 is a block diagram illustrating a hardware configuration example of the vehicle control device 10 and the vehicle control device 10B.

The vehicle control device 10 and the vehicle control device 10B have a hardware configuration using a normal computer in which a central processing unit (CPU) 80A, a read only memory (ROM) 80B, a random access memory (RAM) 80C, an I/F 80D for connecting to various devices, and the like are connected to each other by a bus 80E.

The CPU 80A is an arithmetic device that controls the entire processing of the vehicle control device 10 and the vehicle control device 10B. The RAM 80C stores data necessary for various types of processing by the CPU 80A. The ROM 80B stores programs and the like for implementing various types of processing by the CPU 80A. The I/F 80D is an interface that is connected to an external device or an external terminal via a communication line or the like and transmits and receives data to and from the connected external device or external terminal.

A program for executing the above-described various types of processing executed by each of the vehicle control device 10 and the vehicle control device 10B is provided by being incorporated in the ROM 80B or the like in advance. The program for executing the vehicle control method executed in the present embodiment may be recorded as a file in a format installable or executable in the vehicle control device 10 and the vehicle control device 10B in a computer-readable storage medium such as a CD-ROM, a flexible disk (FD), a CD-R, or a digital versatile disk (DVD) and thereby provided.

In addition, the program for executing the vehicle control method (vehicle display control method) executed in the present embodiment may be stored on a computer connected to a network such as the Internet and provided by being downloaded via the network. In addition, the program for executing the vehicle control method (vehicle display control method) executed in the present embodiment may be provided or distributed via a network such as the Internet.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A vehicle display control method implemented by a computer as a vehicle display control device provided in a vehicle, the vehicle including a camera and a display device, the camera serving to acquire a first peripheral video in a first direction from a first viewpoint, the display device enabling a passenger to visually recognize video, the vehicle display control method comprising:
generating, based on the first peripheral video, a second peripheral video in a second direction from a second viewpoint at a position higher than the first viewpoint by using a learning model, the learning model being trained based on a first training video and a second training video, the first training video being acquired by a first learning camera in the first direction at the first viewpoint, the second training video being acquired by a second learning camera in the second direction at the second viewpoint; and
causing the display device to display an overhead view video viewed from an overhead viewpoint higher than the first viewpoint by using the second peripheral video.

2. The vehicle display control method according to claim 1, wherein the first direction and the second direction indicate different directions.

3. The vehicle display control method according to claim 2, wherein the first direction is closer to a vertical direction than the second direction is.

4. The vehicle display control method according to claim 1, wherein a height of the overhead viewpoint is equal to or higher than a height of the second viewpoint.

5. The vehicle display control method according to claim 1, wherein the camera is located on a lower surface of a housing of a door mirror attached to the vehicle.

6. The vehicle display control method according to claim 1, wherein at least part of a second angle of view of the second peripheral video does not overlap with a first angle of view of the first peripheral video.

7. The vehicle display control method according to claim 1, wherein
the camera is a first camera,
the learning model is a first learning model,
the vehicle further includes a second camera serving to acquire a third peripheral video in a third direction from a third viewpoint,
the vehicle display control method further comprises:
generating the second peripheral video in the second direction from the second viewpoint at a position higher than the first viewpoint by using the first learning model based on the first peripheral video;
generating a fourth peripheral video in a fourth direction from a fourth viewpoint at a position higher than the third viewpoint by using the second learning model based on the third peripheral video; and
causing the display device to display an overhead view video viewed from an overhead viewpoint higher than the first viewpoint by using the second peripheral video and the fourth peripheral video,
the first learning model is trained based on the first training video and the second training video, the first training video being acquired by the first learning camera in the first direction at the first viewpoint, the second training video being acquired by the second learning camera in the second direction at the second viewpoint, and
the second learning model is trained based on a third training video and a fourth training video, the third training video being acquired by a third learning camera in the third direction at the third viewpoint, the fourth training video being acquired by a fourth learning camera in the fourth direction at the fourth viewpoint.

8. The vehicle display control method according to claim 7, wherein the first learning model and the second learning model are same.

9. The vehicle display control method according to claim 7, wherein
a height of the first viewpoint and a height of the third viewpoint are equal to each other, and
a height of the second viewpoint and a height of the fourth viewpoint are equal to each other.

10. The vehicle display control method according to claim 7, wherein
the vehicle further includes
a third camera serving to acquire a fifth peripheral video in a fifth direction from a fifth viewpoint, and
a fourth camera serving to acquire a sixth peripheral video in a sixth direction from a sixth viewpoint, and
the vehicle display control method further comprises:
generating the second peripheral video in the second direction from the second viewpoint at a position higher than the first viewpoint by using the first learning model based on the first peripheral video;
generating the fourth peripheral video in the fourth direction from the fourth viewpoint at a position higher than the third viewpoint by using the second learning model based on the third peripheral video; and
causing the display device to display an overhead view video viewed from an overhead viewpoint higher than the first viewpoint by using the second peripheral video, the fourth peripheral video, the fifth peripheral video, and the sixth peripheral video.

11. A vehicle display control device provided in a vehicle, the vehicle including a camera and a display device, the camera serving to acquire a first peripheral video in a first direction from a first viewpoint, the display device enabling a passenger to visually recognize video, the vehicle display control device comprising:
a memory in which a computer program is stored; and
a processor connected to the memory and configured to perform processing by executing the computer program, the processing including
generating, based on the first peripheral video, a second peripheral video in a second direction from a second viewpoint at a position higher than the first viewpoint by using a learning model, the learning model being trained based on a first training video and a second training video, the first training video being acquired by a first learning camera in the first direction at the first viewpoint, the second training video being acquired by a second learning camera in the second direction at the second viewpoint, and
causing the display device to display an overhead view video viewed from an overhead viewpoint higher than the first viewpoint by using the second peripheral video.

12. The vehicle display control device according to claim 11, wherein the first direction and the second direction indicate different directions.

13. The vehicle display control device according to claim 12, wherein the first direction is closer to a vertical direction than the second direction is.

14. The vehicle display control device according to claim 11, wherein a height of the overhead viewpoint is equal to or higher than a height of the second viewpoint.

15. The vehicle display control device according to claim 11, wherein the camera is located on a lower surface of a housing of a door mirror attached to the vehicle.

16. The vehicle display control device according to claim 11, wherein at least part of a second angle of view of the second peripheral video does not overlap with a first angle of view of the first peripheral video.

17. The vehicle display control device according to claim 11, wherein
the camera is a first camera,
the learning model is a first learning model,
the vehicle further includes a second camera serving to acquire a third peripheral video in a third direction from a third viewpoint,
the processing executed by the processor further includes:
generating the second peripheral video in the second direction from the second viewpoint at a position higher than the first viewpoint by using the first learning model based on the first peripheral video;
generating a fourth peripheral video in a fourth direction from a fourth viewpoint at a position higher than the third viewpoint by using the second learning model based on the third peripheral video; and
causing the display device to display an overhead view video viewed from an overhead viewpoint higher than the first viewpoint by using the second peripheral video and the fourth peripheral video,
the first learning model is trained based on the first training video and the second training video, the first training video being acquired by the first learning camera in the first direction at the first viewpoint, the second training video being acquired by the second learning camera in the second direction at the second viewpoint, and
the second learning model is trained based on a third training video and a fourth training video, the third training video being acquired by a third learning camera in the third direction at the third viewpoint, the fourth training video being acquired by a fourth learning camera in the fourth direction at the fourth viewpoint.

18. The vehicle display control device according to claim 17, wherein the first learning model and the second learning model are same.

19. The vehicle display control device according to claim 17, wherein
a height of the first viewpoint and a height of the third viewpoint are equal to each other, and
a height of the second viewpoint and a height of the fourth viewpoint are equal to each other.

20. The vehicle display control device according to claim 17, wherein
the vehicle further includes
a third camera serving to acquire a fifth peripheral video in a fifth direction from a fifth viewpoint, and
a fourth camera serving to acquire a sixth peripheral video in a sixth direction from a sixth viewpoint, and
the processing executed by the processor further includes:
generating the second peripheral video in the second direction from the second viewpoint at a position higher than the first viewpoint by using the first learning model based on the first peripheral video;
generating the fourth peripheral video in the fourth direction from the fourth viewpoint at a position higher than the third viewpoint by using the second learning model based on the third peripheral video; and
causing the display device to display an overhead view video viewed from an overhead viewpoint higher than the first viewpoint by using the second peripheral video, the fourth peripheral video, the fifth peripheral video, and the sixth peripheral video.
